(19) United States
(12) Patent Application Publication
(10) Pub. No.: US 2016/0092031 A1
(43) Pub. Date: Mar. 31, 2016

(54) VIRTUAL TWO-DIMENSIONAL POSITIONING MODULE OF INPUT DEVICE AND VIRTUAL DEVICE WITH THE SAME

(71) Applicant: SERAFIM TECHNOLOGIES INC., New Taipei City (TW)

(72) Inventor: Guo-Zen CHEN, New Taipei City (TW)

(21) Appl. No.: 14/864,126

(22) Filed: Sep. 24, 2015

(30) Foreign Application Priority Data
Sep. 25, 2014 (TW) 103133145
Dec. 16, 2014 (TW) 103222281

(51) Int. Cl. G06F 3/042; G06F 3/0488

(52) U.S. Cl. CPC G06F 3/0421; G06F 3/04886

(57) ABSTRACT

A virtual two-dimensional positioning module of an input device and a virtual input device with the same are revealed. The module set on a plane in use includes an infrared (IR) laser light source, at least two line sensors and a controller. The IR laser light source is for projecting a horizontal IR laser to form a two-dimensional light curtain over and parallel to the plane. The line sensors are arranged separately and used for detecting reflected light caused by a user-controlled object entered into the two-dimensional light curtain to generate a linear position signal respectively. The controller is used to receive the linear position signals from the line sensors and perform processing to get position of the user-controlled object in a two-dimensional coordinate system of the two-dimensional light curtain.

### BACKGROUND OF THE INVENTION

The present invention relates to a virtual two-dimensional positioning module of an input device, especially to a two-dimensional positioning module of an input device and a virtual input device having the same. The two-dimensional positioning module includes an infrared laser light, at least two virtual line sensors and a controller. The virtual input device has a mask-shaped or a helmet-shaped housing.

The present invention involves a virtual two-dimensional positioning module of an input device. The input device is a transmission interface that drives an application device to work through data input. For example, a user interface or a Human Interface Device (HID) is a transmission interface. The user interface is divided into two types-touch controlled type and remote controlled type.

The touch controlled use interface consists of a plurality of different touch controlled systems and methods such as resistive, capacitive, Surface Acoustic Wave (SAW), infrared (IR), optical imaging, etc. Instead of a button or a joystick, a user-controlled object such as finger or stylus pen is used to contact the touch screen display for control of various functions of a display including pointing-and-clicking, page switching, zooming in/out and touch games.

Refer to US 2009/0200453, U.S. Pat. No. 7,538,759, U.S. Pat. No. 7,692,625, and U.S. Pat. No. 7,629,967, techniques related to optical touch are revealed. A light source such as a LED is disposed on one of four sides or corners of a panel (display) to form a screen. Light reflecting/absorbing strips perpendicular to one another and at least two sensors such as cameras are arranged at four edges of the panel. The sensing directions of the sensors are crossed. When a user-controlled object such as finger or stylus pen is in contact with the panel, the user-controlled object causes scattering or shielding of the screen. The position of the user-controlled object can be learned by the at least two sensors through reflection/absorption of the light reflecting/absorbing strips. Then a processor is used to get an actual coordinate of the user-controlled object on the panel. Thus functions of the optical touch system are provided. The optical touch system available now uses detection of the two sensors (cameras) and processing of the processor to achieve positioning in a two-dimensional coordinate system of the panel. However, most of the light source used now is LED. Light emitted from LED is not highly coherent and easy to be affected by external stray light. Thus the sensitivity of the touch control system is unable to be improved significantly. However, the system needs to be used together with light reflecting/absorbing strips on the edges. The system architecture is more complicated, the cost is increased and the system stability is affected. Dust and dirt are easy to attach to the edges and this affects the touch control. The two-dimensional positioning techniques of the optical touch system available now are unable to be applied to the present invention.

Refer to U.S. Pat. No. 5,168,531, U.S. Pat. No. 5,198,877, U.S. Pat. No. 5,448,263, U.S. Pat. No. 5,617,312, U.S. Pat. No. 5,627,565, U.S. Pat. No. 5,767,842, U.S. Pat. No. 5,798,519, U.S. Pat. No. 5,933,132, U.S. Pat. No. 5,969,698, U.S. Pat. No. 6,037,882, U.S. Pat. No. 6,043,805, U.S. Pat. No. 6,104,387, U.S. Pat. No. 6,115,128, U.S. Pat. No. 6,229,913, U.S. Pat. No. 6,252,598, U.S. Pat. No. 6,266,048, U.S. Pat. No. 6,281,878, U.S. Pat. No. 6,323,942, U.S. Pat. No. 6,424,334, U.S. Pat. No. 6,512,838, U.S. Pat. No. 6,522,312, U.S. Pat. No. 6,614,422, U.S. Pat. No. 6,690,354, U.S. Pat. No. 6,690,618, U.S. Pat. No. 6,710,770, U.S. Pat. No. 7,006,236, U.S. Pat. No. 7,050,177, U.S. Pat. No. 7,151,530, US2012/0162077, US2014/0055364, techniques related to a virtual input device such as virtual keyboard formed by projection are revealed. Take U.S. Pat. No. 6,614,422, US2012/0162077, and US2014/0055364 as an example. A system using a virtual input device for data input and a method of the same are revealed. The virtual input device can be a virtual keyboard or a virtual mouse. However, these prior arts still have shortcomings of complicated system structure and difficulty in miniaturization. This has negative effect on applications of various input devices and also affects the efficiency in use.

Moreover, the remote controlled user interface includes an object (control member) such as hand gesture or a part of human body that moves or change positions within a three-dimensional X, Y, Z space for remote control of various functions of the display. The object (control member) is not in contact with the display directly. Refer to WO 03/071410, U.S. Pat. No. 7,348,963, U.S. Pat. No. 7,433,024, U.S. Pat. No. 6,560,019, US 2008/0240502, US 2008/0106746, US 2009/0185274, US 2009/0096783, US 2009/0034649, US 2009/0185274, US 2009/0183125, US 2010/0020078, TW 200847061, TW 201033938, TW 201003564, TW 201010424, and TW 201112161, techniques related to the remote controlled user interface are revealed. Although the remote controlled user interface has a positioning function in the three-dimensional space, it has the following shortcomings in applications. Firstly, the remote controlled user interface available now generally includes two image-capturing cameras to detect and capture images of relative positions and/or movement of the object (control member) in the three-dimensional space for coordinate positioning and processing (three-dimensional positioning). There is a risk of the camera and images being hacked. The coordinate positioning and processing results in increasing processing amount of the controller and the software used is getting complicated. The user interface includes more components so that the production cost is unable to be lowered. A larger three-dimensional X-Y-Z space is required for arrangement of related components such as two image-capturing cameras or infrared laser light. The components are arranged at higher positions with respect to one another. Thus the interface is difficult or unable to be miniaturized. Thus the remote controlled user interface is also unable or difficult to be applied to various input devices, especially the input device for two-dimensional positioning and related applications. For example, the interface is used in combination with a projector to form a virtual keyboard, a virtual switch, an access control system, etc.

In a technical field of a virtual two-dimensional positioning module of an input device and applications, there is an urgent need to develop a virtual two-dimensional positioning module of an input device that reduces the risk of being hacked, reducing processing amount of the controlled, lowered the production cost, miniaturized design, and easy to be introduced into various input devices. Moreover, electronics are used together with an input device for compact design and low noise. The input device having character keys or digital key can be a keyboard, a numeric keyboard, or a mouse including a left button and a right button, allowing users to click and input related information. However, there is limitation in reduction of the size of the input device. Although some other devices such as boogie board, voice input device, light pen, etc are available now, users are accustomed to using keyboards or mice.

Thus products such as virtual keyboards have been developed. A fixed keyboard image is generated by hologram technology or optical scanning. Then a detection light beam is used to detect operating commands the user input through the virtual keyboard. The user only need to carry a projector for operating the keyboard and data input. The virtual keyboard has advantages of no noise, compact size, portability and easiness to be used in various places.

Although such products are available on the market, the structure of these products has not been modified to have aesthetic and decorative appearance. The products are not so attractive for users. Thus there is room for improvement and a need to provide a product with higher value added.

### SUMMARY OF THE INVENTION

Therefore it is a primary object of the present invention to provide a virtual two-dimensional positioning module of an input device including an infrared (IR) laser light, at least two line sensors and a controller for virtual positioning in a two-dimensional coordinate system and reducing the risk of an image-capturing camera being hacked. The IR laser light projects light to form a two-dimensional (X-Y) light curtain. The two line sensors are arranged separately with a distance therebetween and used for detecting reflected light caused by a user-controlled object entered into the two-dimensional (X-Y) light curtain to generate a linear position signal respectively. The controller such as MCU (microcontroller unit) is used for receiving the linear position signals from the line sensors and performing processing to get the position of the user-controlled object in a two-dimensional coordinate system of the two-dimensional (X-Y) light curtain. Moreover, the virtual two-dimensional positioning module has advantages of less amount of processing performed by the controller, lower production cost, compact/modularized design, etc. This is beneficial to the introduction of the present module into various input devices. For example, the module of the present invention is used together with a projector to form an input device such as a virtual keyboard, an access control system, a virtual mouse, a virtual switch, etc. Thus the functions and application range of the virtual two-dimensional positioning module of the present invention are getting wider.

The virtual two-dimensional positioning module is used together with a projector and/or activation unit to form a virtual keyboard used as an input device. The activation unit detects whether a user-controlled object is approaching. If yes, the virtual two-dimensional positioning module is turned on and the projector is further activated through the controller thereof. Thus a virtual keyboard with common keyboard layout is formed in the two-dimensional (X-Y) light curtain by projection of the virtual two-dimensional positioning module. When the user-controlled object has entered into the two-dimensional light curtain corresponding to the virtual keyboard, the position of the user-controlled object in a two-dimensional coordinate system corresponding to the virtual keyboard (the two-dimensional light curtain) is obtained through the virtual two-dimensional positioning module. Thus both virtual positioning in the two-dimensional coordinate system and preset functions of the virtual keyboard (the two-dimensional light curtain) are achieved. Therefore the system architecture of the virtual keyboard as a form of input device is simplified.

The virtual two-dimensional positioning module is used in combination with a projector and/or activation unit, or a sensor unit to form a virtual numeric keyboard for a combination lock of an access control system. The activation unit is used for detecting whether a user-controlled object is getting closer. Or the sensor unit is used to detect/recognize the user (such as near field communication (NFC) or identification (ID) card) is matched. If yes, the virtual two-dimensional positioning module is activated and the projector is further activated through the controller thereof. Thus a virtual numeric keyboard with common layout is formed in a two-dimensional (X-Y) light curtain of the virtual two-dimensional positioning module. When the user-controlled object has entered into the two-dimensional light curtain corresponding to the virtual numeric keyboard, the position of the user-controlled object in a two-dimensional coordinate system of the virtual numeric keyboard (the two-dimensional light curtain) is learned through the virtual two-dimensional positioning module. Thus both virtual positioning in the two-dimensional coordinate system and preset system functions of the virtual numeric keyboard for the combination lock of the access control system are achieved. Therefore the system architecture of the input device for the combination lock of the access control system is simplified.

The virtual two-dimensional positioning module is used together with a projector and/or activation unit to form a virtual mouse used as an input device. The activation unit is used to detect whether a user-controlled object is approaching. If yes, the virtual two-dimensional positioning module is turned on and the projector is further turned on through the controller thereof. Thus a virtual mouse with common mouse layout and keys is formed in a two-dimensional (X-Y) light curtain by projection of the virtual two-dimensional positioning module. The position of the user-controlled object in a two-dimensional coordinate system corresponding to the virtual mouse (the two-dimensional light curtain) is obtained through the virtual two-dimensional positioning module when the user-controlled object has entered the two-dimensional light curtain of the virtual mouse. Thus both virtual positioning in the two-dimensional coordinate system and preset system functions of the virtual mouse are achieved. Therefore the structure of the virtual mouse as a form of input device is simplified.

The virtual two-dimensional positioning module is used together with a projector and/or activation unit to form a virtual switch used as an input device. The activation unit detects whether a user-controlled object is getting closer. If yes, the virtual two-dimensional positioning module is activated and the projector is further activated through the controller thereof. Thus a virtual switch with general switch layout is formed in a two-dimensional (X-Y) light curtain by projection of the virtual two-dimensional positioning module. The position of the user-controlled object in a two-dimensional coordinate system of the virtual switch (the two-dimensional light curtain) is obtained through the virtual two-dimensional positioning module when the user-controlled object has entered the two-dimensional light curtain. Thus both virtual positioning in the two-dimensional coordinate system and preset functions of the virtual switch are achieved. For example, the virtual switch is changed from an original “off” state to an “on” state when the user-controlled object (such as finger) has entered the two-dimensional light curtain of the virtual switch. Once the user-controlled object (such as finger) is detected again, the virtual switch is shifted from the “on” state to the “off” state. Therefore the system architecture of the virtual switch as an input device is simplified.

The controller includes a processor such as a microcontroller unit (MCU) or a central processing unit (CPU). The processor is used for control of action of the infrared (IR) laser light, the at least two line sensors, the projector, and the activation unit and signal transmission therebetween such as checking activation signal of the activation unit, activating the projector to perform projection, and detecting and receiving coordinate signals of the two line sensors. Thus the system functions of the present invention and an input device having the same are achieved.

It is another object of the present invention to provide a virtual input device that overcomes shortcomings of the techniques available now. Moreover, the virtual input device has advantages in structure and use, with simple structure, lower production cost and easy maintenance.

In order to achieve the above objects, a virtual input device of the present invention set on a plane in use includes a housing, a light source, at least two line sensors and a projector. The housing is a mask or a helmet having a front surface formed by a forehead part, an eye part, a cheek part and a mouth part. The front surface is face-shaped. The light source is an IR laser light mounted in the housing and corresponding to the mouth part of the housing. Light emitted from the light source is passed through the mouth part to form a two-dimensional (X-Y) light curtain over the plane. The at least two line sensors are disposed in the housing with an interval therebetween and used for detecting reflected light caused by light emitted from the light source being stopped by the user-controlled object located in the two-dimensional (X-Y) light curtain to generate a linear position signal respectively. The projector is mounted in the housing and corresponding to the forehead part of the housing so as to project a virtual input image to the two-dimensional (X-Y) light curtain. The virtual input image can be an image of a virtual keyboard, an image of a virtual numeric keyboard, or an image of a virtual mouse.

The virtual input device further includes a controller and two indicator lights. The controller is mounted in the housing and used for receiving the linear position signals from the at least two line sensors and further processing the linear position signals to get the position of the user-controlled object in a two-dimensional coordinate system of the two-dimensional light curtain.

The two indicator lights are mounted in the housing symmetrically with a certain interval therebetween and corresponding to the cheek part of the housing. When the virtual input image is an image of the virtual mouse formed by projection of the projector, the two indicator lights are used for indicating the left button and the right button of the mouse respectively.

### BRIEF DESCRIPTION OF THE DRAWINGS

FIG. 1 is a schematic drawing showing a top view of an embodiment of a virtual two-dimensional positioning module of an input device in use according to the present invention;

FIG. 1A is a waveform of a linear position signal generated by a line sensor of an embodiment according to the present invention;

FIG. 2 is a schematic drawing showing a front view of the embodiment in FIG. 1 according to the present invention;

FIG. 3 is a schematic drawing showing a side view of the embodiment in FIG. 1 according to the present invention;

FIG. 4 is a schematic drawing showing an embodiment of a virtual two-dimensional positioning module applied to a virtual keyboard as an input device according to the present invention;

FIG. 5 is a schematic drawing showing an embodiment of a virtual two-dimensional positioning module applied to a virtual combination lock of an access control system according to the present invention;

FIG. 6 is a schematic drawing showing an embodiment of a virtual two-dimensional positioning module applied to a virtual mouse as an input device according to the present invention;

FIG. 7 is a schematic drawing showing an embodiment of a virtual two-dimensional positioning module applied to a virtual switch as an input device according to the present invention;

FIG. 8 is a perspective view of an embodiment of a virtual input device according to the present invention;

FIG. 9 is a schematic drawing showing a top view of an embodiment of a virtual input device in use according to the present invention;

FIG. 10 is a schematic drawing showing a front view of the embodiment in FIG. 9 according to the present invention;

FIG. 11 is a schematic drawing showing a side view of the embodiment in FIG. 9 according to the present invention;

FIG. 12 is a schematic drawing showing an embodiment of a virtual input device applied to a virtual keyboard for input according to the present invention;

FIG. 13 is a schematic drawing showing an embodiment of a virtual device applied to a virtual numeric keyboard for input according to the present invention;

FIG. 14 is a schematic drawing showing an embodiment of a virtual device applied to a virtual mouse for input according to the present invention.

### DETAILED DESCRIPTION OF THE PREFERRED EMBODIMENTS

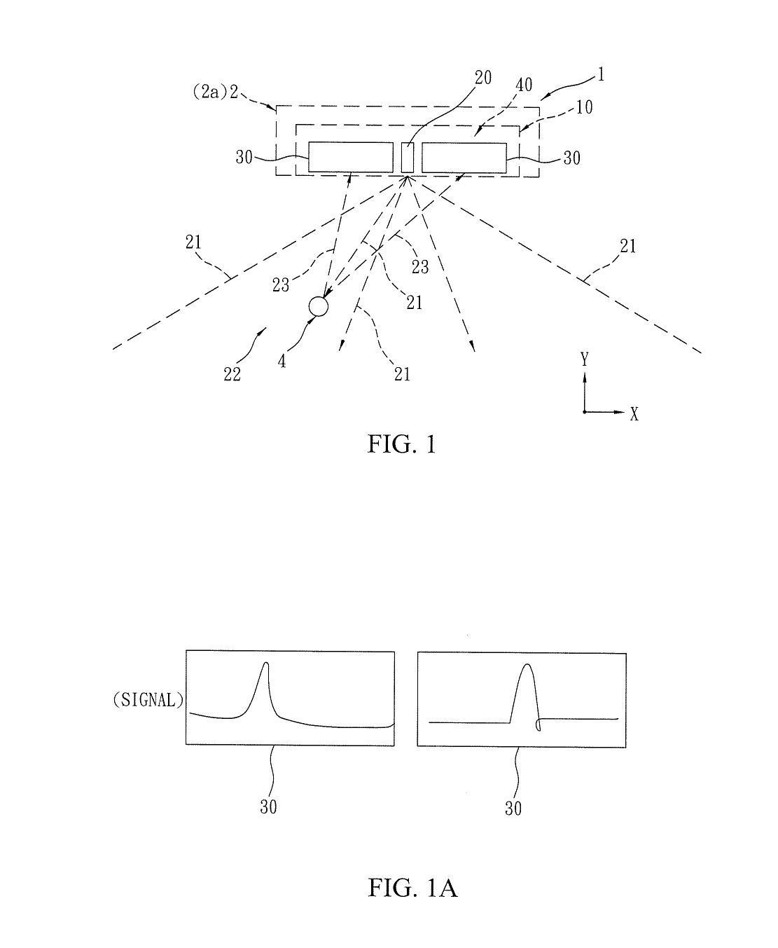

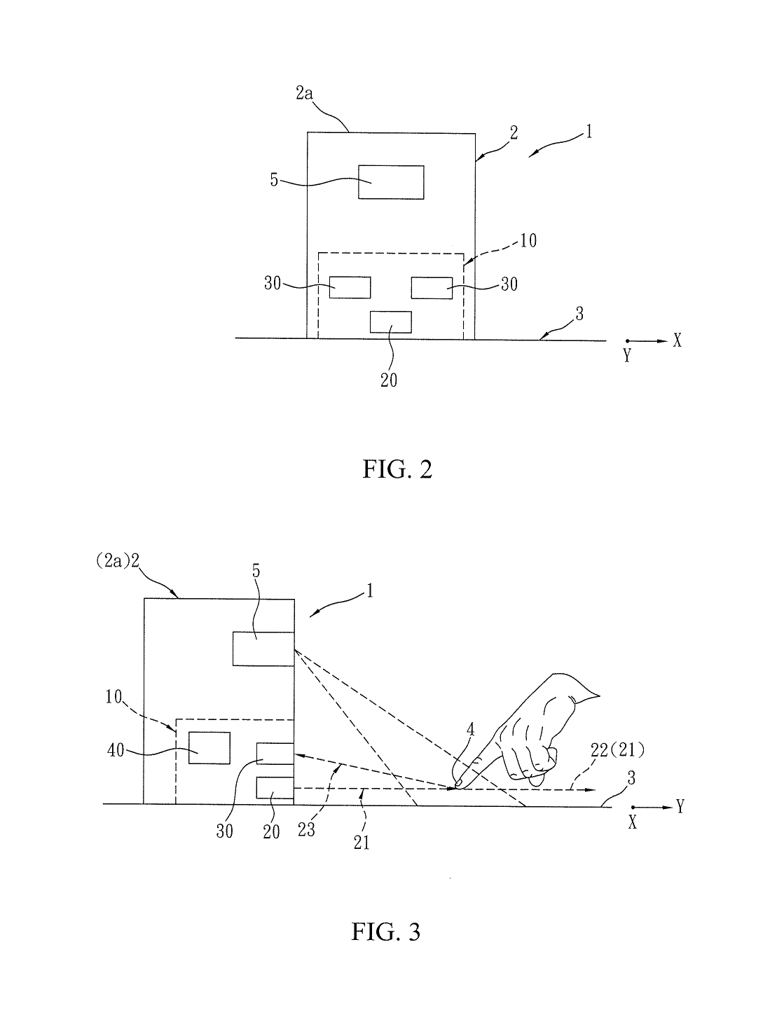

Refer to FIG. 1, FIG. 2 and FIG. 3, a virtual two-dimensional positioning module 1 of an input device according to the present invention is disposed in an object 10 (such as a machine body formed by a housing). The module can also be used together with related devices 2 (such as a projector) and arranged in an object 2a formed by the related device 2 (such as a projector), as shown in FIG. 1 to FIG. 6. The virtual two-dimensional positioning module 1 mainly includes an infrared (IR) laser light 20, at least two line sensors 30, and a controller (such as a microcontroller unit, MCU) 40. While in use, the virtual two-dimensional positioning module 1, the object 10 or other object 2a is set on a plane 3.

As shown in FIG. 1 and FIG. 3, the IR laser light 20 projects a horizontal IR laser light beam 21 so that a two-dimensional (X-Y) light curtain 22 with a certain range, close and parallel to the plane 3 is formed by the horizontal IR laser light beam 21 and located over the plane 3. In order to make the horizontal IR laser light beam 21 projected by the IR laser light 20 form the two-dimensional (X-Y) light curtain 22 (as shown in FIG. 3), a laser light emitted from the IR laser light 20 is passed through a wide-angle optical element such as line generator optics. Thus a light fan after reflection is larger than 90 degrees and a wide-angle linear light beam is formed on surface of the plane 3. That's the two-dimensional (X-Y) light curtain 22, as shown in FIG. 1. The way of forming the two-dimensional (X-Y) light curtain 22 is not limited in the present invention.

The at least two line sensors 30 are arranged with a certain distance therebetween. As shown in FIG. 1 and FIG. 2, the line sensors 30 can be disposed on the left side and the right side of the IR laser light 20 respectively and parallel to each other. While in use, a reflected light 23 is generated due to the horizontal IR laser light beam 21 stopped by a user-controlled object 4 when the user-controlled object 4 (such as finger as shown in FIG. 3) has entered the two-dimensional (X-Y) light curtain 22. Then the two line sensors 30 detect the reflected light 23 caused by the user-controlled object 4 such as the finger and generate a linear position signal respectively, as shown in FIG. 1A.

The controller 40 is a microcontroller unit (MCU) or a central processing unit (CPU) used for receiving the linear position signals (as shown in FIG. 1A) from the at least two line sensors 30 and processing the linear position signals to get the position of the user-controlled object 4 in a two-dimensional coordinate system (X-Y) corresponding to the two-dimensional (X-Y) light curtain 22 for achieving two-dimensional positioning.

The controller 40 performs processing (such as of the linear position signals (as shown in FIG. 1A) from the at least two line sensors 30. Compared with the techniques available now (such as US2012/0162077, US2014/0055364, etc.) that performs processing by using signals from images captured by a camera, the processing of the controller 40 in the present invention is simplified. Moreover, there is no limit on the position of the controller 40 in the virtual two-dimensional positioning module 1 or the object 10.

In the virtual two-dimensional positioning module 1, the at least two line sensors 30 are used to replace the camera for capturing images in conventional techniques. The design not only reduces the risk of the camera being hacked but also has the advantages of less amount of processing performed by the controller, lower production cost, compact/modularized design, etc. This is beneficial to the introduction of the present module into various input devices. For example, the module of the present invention is used in combination with other devices for projection to form an input device such as a virtual keyboard, an access control system, a virtual switch, etc. Thus the virtual two-dimensional positioning module 1 of the present invention has more functions and applications.

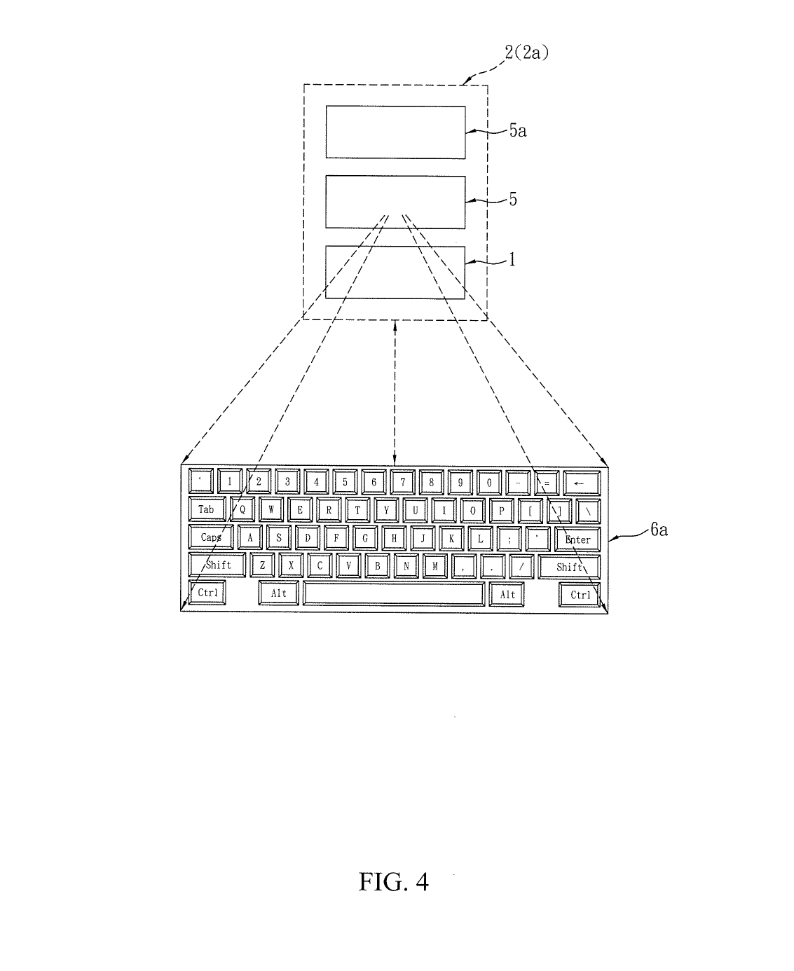

Refer to FIG. 4, the virtual two-dimensional positioning module 1 of the present invention is applied to a virtual keyboard used as an input device. In this embodiment, the virtual two-dimensional positioning module 1 of the present invention is used together with a projector 5 (the related device 2) and an activation unit 5a to form a virtual keyboard. The virtual two-dimensional positioning module 1, the projector 5 and the activation unit 5a are mounted in an object 2a formed by the related device 2 (as shown in FIG. 4). While in use, the activation unit 5a detects whether the user-controlled object 4 is approaching. If the answer is yes, the virtual two-dimensional positioning module 1 is turned on. And the projector 5 is further activated by the controller 40 of the virtual two-dimensional positioning module 1. Thus a virtual keyboard 6a with common keyboard layout is formed in the two-dimensional (X-Y) light curtain 22 by projection of the virtual two-dimensional positioning module 1. When the user-controlled object 4 has entered into the two-dimensional light curtain 22 corresponding to the virtual keyboard 6a, the position of the user-controlled object 4 in a two-dimensional coordinate system corresponding to the two-dimensional light curtain 22 of the virtual keyboard 6a is obtained through detection and processing of the virtual two-dimensional positioning module 1. Thus both virtual positioning in the two-dimensional coordinate system and preset functions of the virtual keyboard 6a (the two-dimensional light curtain 22) are achieved. Therefore the system architecture of the virtual keyboard 6a as a form of input device is simplified.

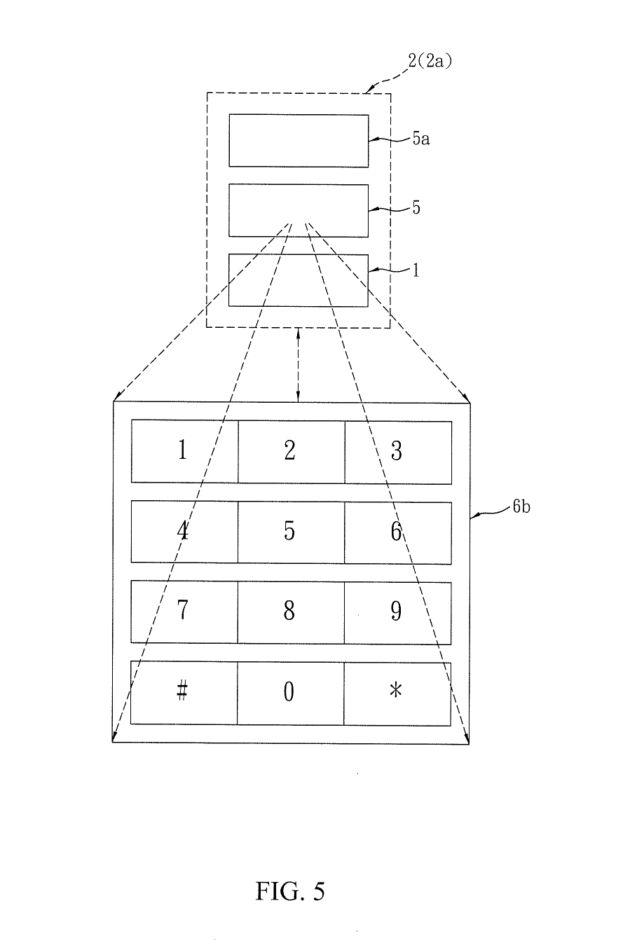

Refer to FIG. 5, a virtual two-dimensional positioning module 1 of an input device is applied to a virtual numeric keyboard for a combination lock of an access control system (as an input device). In this embodiment, the virtual two-dimensional positioning module 1 of the present invention is used in combination with a projector 5 (the related device 2) and an activation unit (or a sensor unit) 5a to form a virtual numeric keyboard for a combination lock of an access control system. The virtual two-dimensional positioning module 1, the projector 5 and the activation unit 5a are mounted in an object 2a formed by the related device 2 (as shown in FIG. 5). While being used, the activation unit (the sensor unit) 5a is used to detect whether the user-controlled object 4 is getting closer or the activation unit 5a is used to detect/recognize whether the user's NFC (near field communication) or ID (identification) card is matched. If the answer is yes, the virtual two-dimensional positioning module 1 is activated. The projector 5 is further turned on through the controller 40 of the present invention. Thus a virtual numeric keyboard 6b is formed in the two-dimensional (X-Y) light curtain 22 by projection of the virtual two-dimensional positioning module 1. As shown in FIG. 3, the position of the user-controlled object 4 in a two-dimensional coordinate system corresponding to the two-dimensional light curtain 22 of the virtual numeric keyboard 6b is learned through sensing and processing of the virtual two-dimensional positioning module 1 when the user-controlled object 4 has entered into the two-dimensional light curtain 22 corresponding to the virtual numeric keyboard 6b. Thus both virtual positioning in the two-dimensional coordinate system and preset system functions of the virtual numeric keyboard 6b (the two-dimensional light curtain 22) are achieved. Therefore the system architecture of the input device for the combination lock of the access control system is simplified.

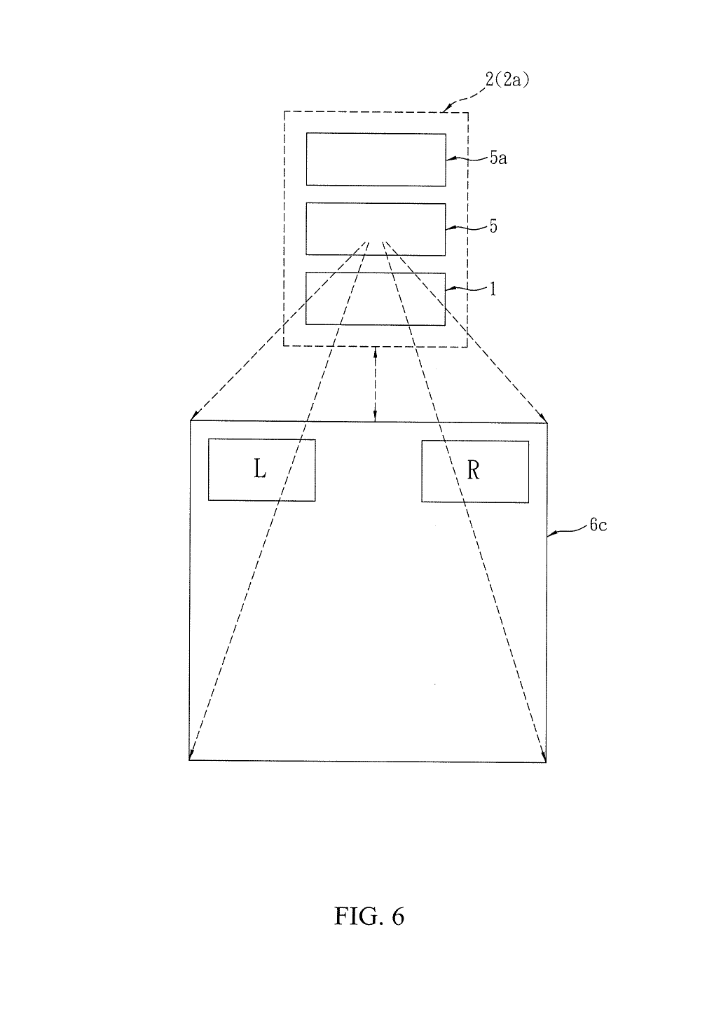

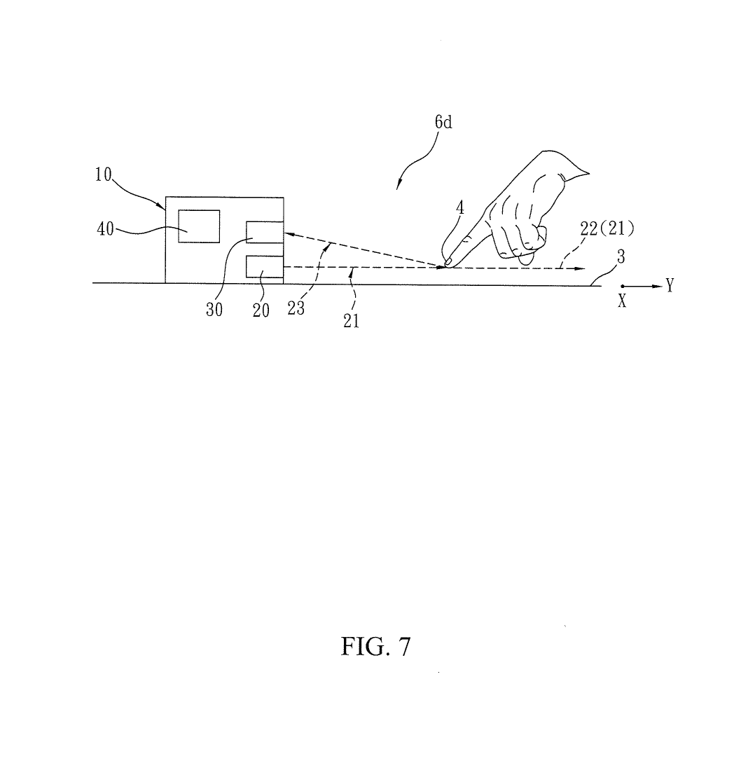

Refer to FIG. 6, the virtual two-dimensional positioning module 1 of the present invention is applied to a virtual mouse used as an input device. In this embodiment, the virtual two-dimensional positioning module 1 of the present invention is used together with a projector 5 (the related device 2) and an activation unit 5a to form a virtual mouse. The virtual two-dimensional positioning module 1, the projector 5 and the activation unit 5a are mounted in an object 2a formed by the related device 2 (as shown in FIG. 6). \While in use, the activation unit 5a is used to detect whether the user-controlled object 4 is approaching (as shown in FIG. 3). If yes, the virtual two-dimensional positioning module 1 is activated. The projector 5 is further turned on through the controller 40 of the virtual two-dimensional positioning module 1. Thus a virtual mouse 6c with common mouse layout and keys is formed in the two-dimensional (X-Y) light curtain 22 by projection of the virtual two-dimensional positioning module 1. When the user-controlled object 4 (as shown in FIG. 3) has entered the two-dimensional light curtain 22 of the virtual mouse 6c such as a left button (L) area, a right button (R) area, or a mouse movement sensing area between the left button and the right button, the position of the user-controlled object 4 in a two-dimensional coordinate system corresponding to the virtual mouse 6c (the two-dimensional light curtain 22) is obtained through detection and processing of the virtual two-dimensional positioning module 1. Thus both virtual positioning in the two-dimensional coordinate system and functions of the virtual mouse 6c are achieved. Therefore the structure of the virtual mouse 6c as a form of input device is simplified.

Refer to FIG. 7, a virtual two-dimensional positioning module of the present invention is applied to a virtual switch as an input device. In this embodiment, the virtual two-dimensional positioning module 1 of the present invention is used independently, without being used together with a projector 5 (the related device 2) and an activation unit 5a shown in FIG. 4, FIG. 5, and FIG. 6. The virtual two-dimensional positioning module 1 is disposed in an object 10 directly and used for forming a virtual switch 6d within the two-dimensional light curtain 22. When the user-controlled object 4 (such as finger) has entered the two-dimensional light curtain 22 corresponding to the virtual switch 6d, the virtual switch 6d is switched from the original “off” state to an “on” state. Once the user-controlled object 4 (such as finger) is detected again, the virtual switch 6d is switched from the “on” state to the “off” state. Thus both virtual positioning in the two-dimensional coordinate system and preset functions of the virtual switch 6d are achieved. Therefore the system architecture of the virtual switch 6d (as a form of) as an input device is simplified.

In the embodiments of the virtual two-dimensional positioning module 1 applied to various input devices, as shown in FIG. 4 to FIG. 6, the activation unit 5a is a sensing element used for detecting whether the user is approaching to use the input device. For example, users can use a user-controlled object to approach the sensing element in the activation unit 5a for being detected and activating the projector 5. Thus a preset virtual figure is formed. The sensing element in the activation unit 5a can be, but not limited to, an image sensor or a proximity sensor.

In an embodiment of the present invention, the controller 40 is a microcontroller unit (MCU) or a central processing unit (CPU) used for controlling action of the infrared (IR) laser light 20, the at least two line sensors 30, the projector 5, and the activation unit 5a, signal transmission such as checking activation signal of the activation unit 5a, activating the projector 5 to perform projection, and detecting and receiving coordinate signals from the two line sensors 30. Thus the system functions of the virtual two-dimensional positioning module of an input device and the input device having the same are achieved.

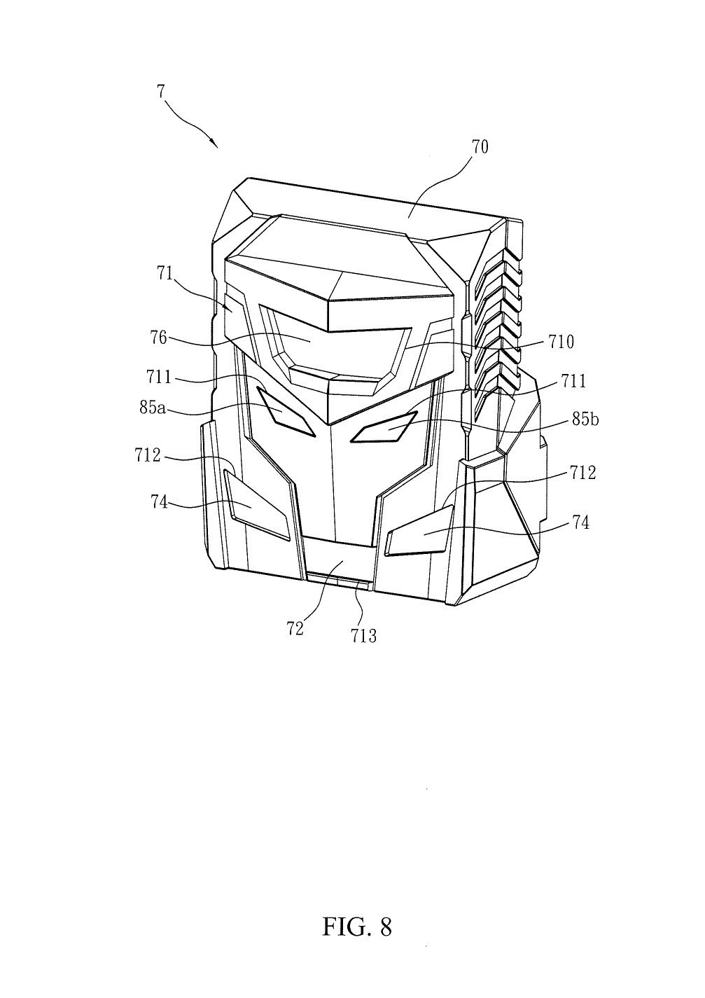

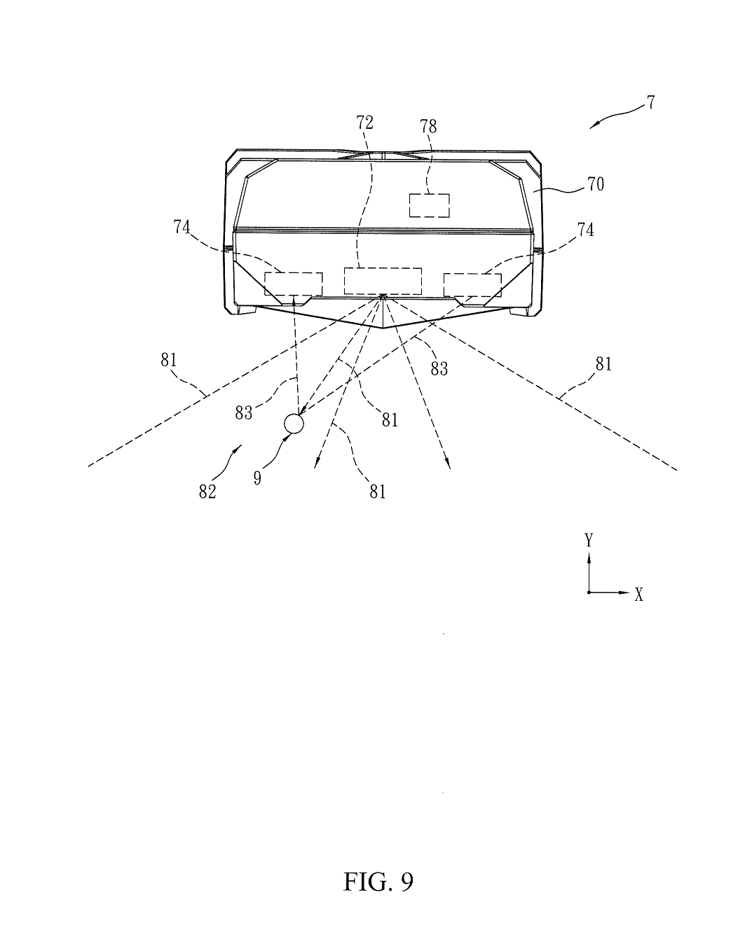

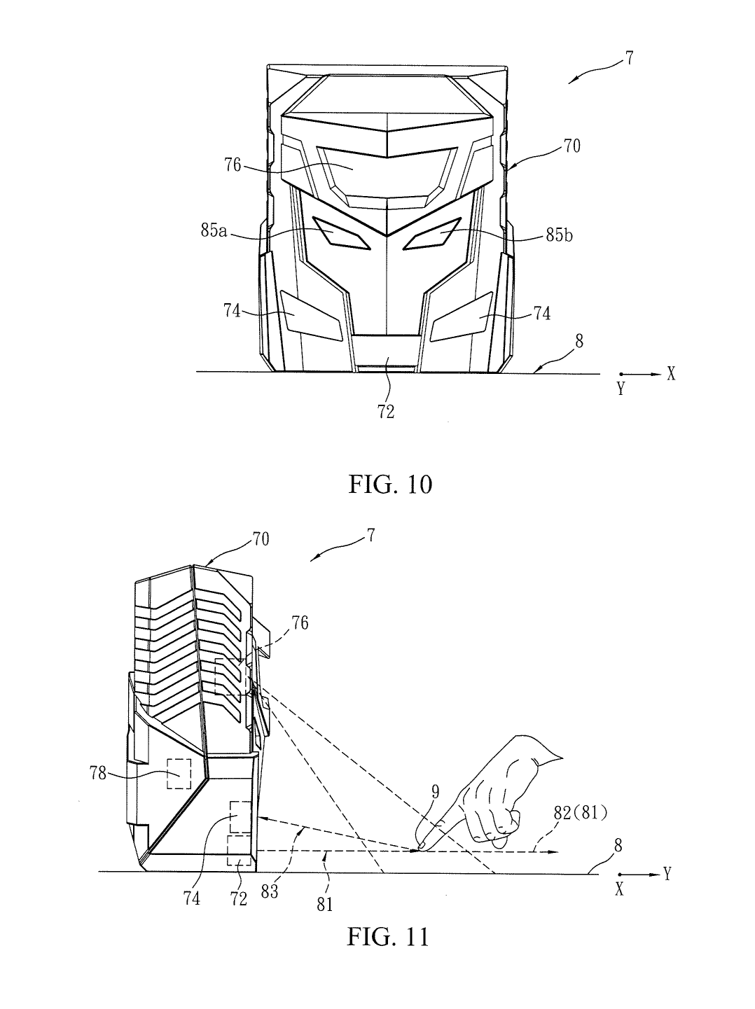

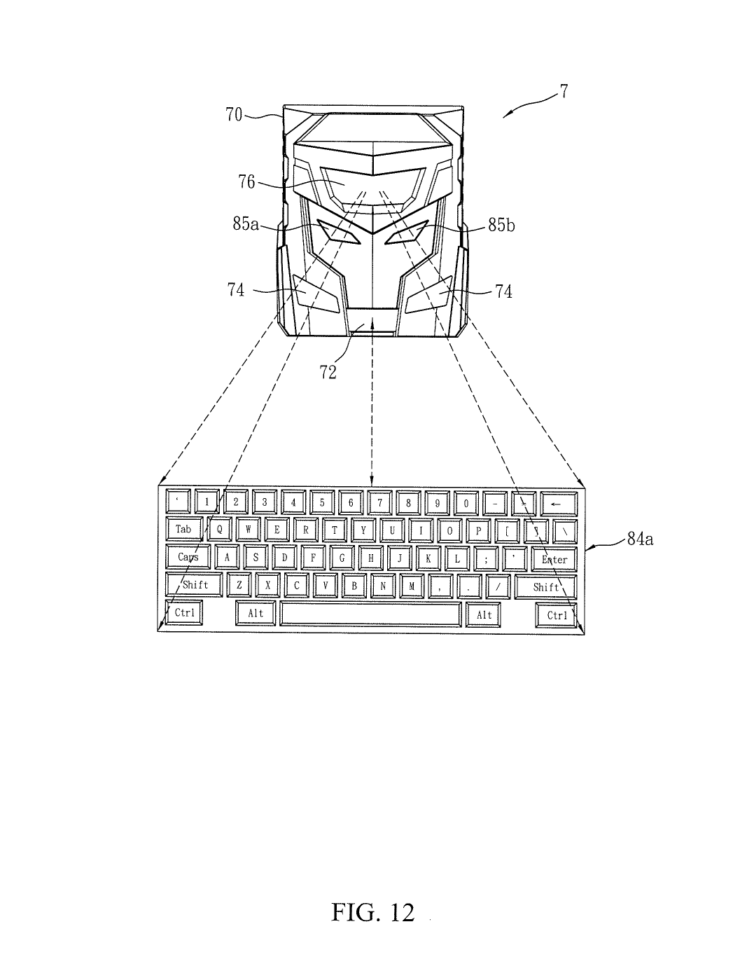

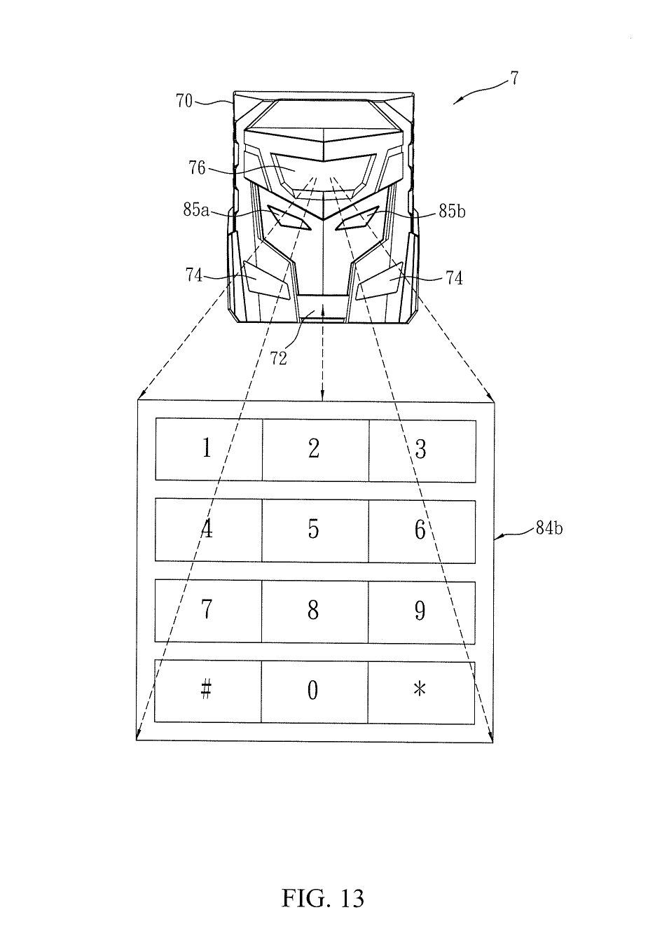

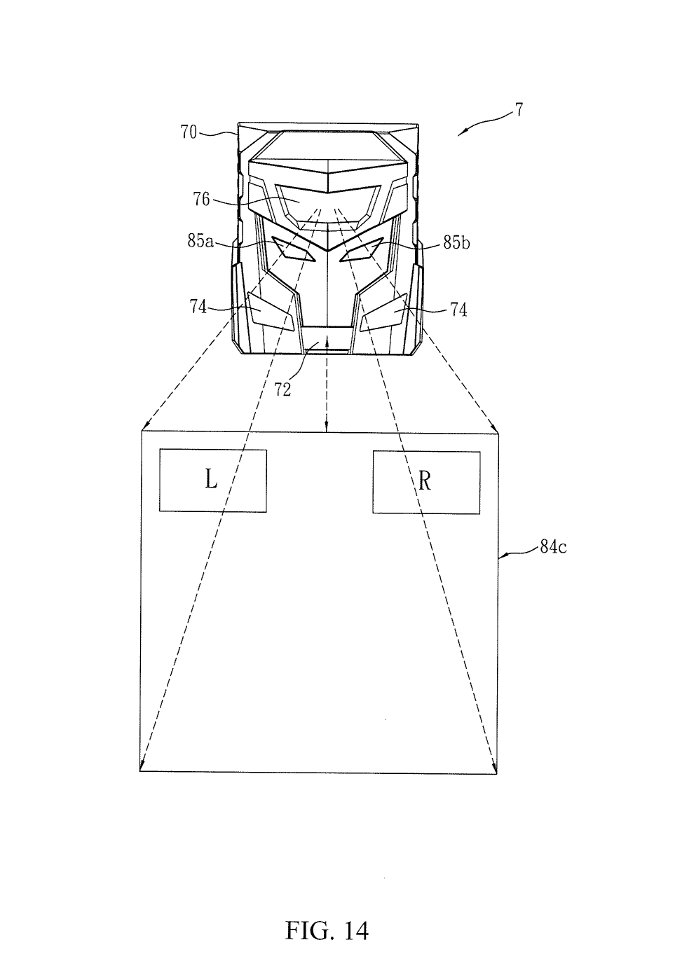

Refer from FIG. 8 to FIG. 14, an embodiment of a virtual input device is revealed. The perspective view of the virtual input device is disclosed in FIG. 8. FIG. 9 is a top view of the virtual input device in use while FIG. 10 shows a front view of the virtual input device in FIG. 9 and FIG. 11 is a side view of the virtual input device in FIG. 9. FIG. 12 shows the virtual input device applied to a virtual keyboard. FIG. 13 is a schematic drawing showing the virtual input device applied to a virtual numeric keyboard. FIG. 14 shows the virtual input device applied to a virtual mouse.

As shown in FIG. 8, FIG. 9 and FIG. 10, the virtual input device 7 is set on a plane 8 in use. The virtual input device 7 includes a housing 70, a light source 72, at least two line sensors 74, a projector 76 and a controller 78.

The housing 70 looks like a mask or a helmet and having a front surface 71. The front surface 71 is face-shaped and composed of a forehead part 710, an eye part 711, a cheek part 712 and a mouth part 713.

The light source 72 is an IR laser light mounted in the housing 70 and corresponding to the mouth part 713 of the housing 70. The light source 72 projects a horizontal IR laser light beam 81 passed through the mouth part 713 so as to form a two-dimensional (X-Y) light curtain 82 with a certain range, located close to, parallel to and over the plane 8. In order to make the horizontal IR laser light beam 81 projected by the light source 72 form the two-dimensional (X-Y) light curtain 82 (as shown in FIG. 11), a laser light beam emitted from the light source 72 (IR laser light) is passed through a wide-angle optical element such as line generator optics. Thus a light fan after reflection is larger than 90 degrees and a wide-angle linear light beam is formed on surface of the plane 8. That's the two-dimensional (X-Y) light curtain 82, as shown in FIG. 9.

The at least two line sensors 74 are disposed in the housing 70 with an interval therebetween and corresponding to the cheek part 72 of the housing 70. As shown in FIG. 8 and FIG. 9, the line sensors 74 are arranged at the left side and the right side of the light source 20 respectively and parallel to each other. A reflected light 83 is generated due to the light from the light source 72 stopped by a user-controlled object 9 when the user-controlled object 9 (such as a finger shown in FIG. 11) has entered the two-dimensional (X-Y) light curtain 82 in usage. Thus the two line sensors 74 detect the reflected light 83 caused by the user-controlled object 9 such as the finger and generate a linear position signal respectively, as shown in FIG. 11.

The projector 76 is mounted in the housing 70 and corresponding to the forehead part 710 of the housing 70 so as to project a virtual input image to the two-dimensional (X-Y) light curtain 82. The virtual input image can be an image of a virtual keyboard, an image of a virtual numeric keyboard, or an image of a virtual mouse.

The controller 78 is a microcontroller unit (MCU) or a central processing unit (CPU) used for receiving the linear position signals from the at least two line sensors 74 and processing the signals to learn the position of the user-controlled object 9 in a two-dimensional coordinate system (X-Y) of the two-dimensional (X-Y) light curtain 82 for two-dimensional positioning. The controller 78 performs processing (such as trigonometry) of the linear position signals from the at least two line sensors 74. Compared with the techniques available now that performs processing of signals obtained by hologram technology or optical scanning, the processing of the controller 78 in the present invention is quite simply.

Refer to FIG. 12, a schematic drawing showing a virtual input device of the present invention is applied to a virtual keyboard for input. While in use, first detect whether the user-controlled object 9 (as shown in FIG. 11) is approaching. If yes, the virtual input device 7 is activated and the projector 76 is further turned on through the controller 78 to project a virtual keyboard 84a with common keyboard layout to the two-dimensional (X-Y) light curtain 82. After the user-controlled object 9 being entered the two-dimensional (X-Y) light curtain 82, the position of the user-controlled object 9 in a two-dimensional coordinate system corresponding to the virtual keyboard 84a (two-dimensional light curtain 82) is obtained through detection and processing of the virtual input device 7. Thus both virtual positioning in the two-dimensional coordinate system and preset system functions of the virtual keyboard 84a (two-dimensional light curtain 82) are achieved. Therefore the system architecture is simplified.

Refer to FIG. 13, a schematic drawing showing a virtual input device of the present invention is applied to a virtual numeric keyboard (for a combination lock of an access control system). While being used, first detect whether the user-controlled object 9 (as shown in FIG. 11) is approaching or detect/recognize whether the user (his NFC or ID card) is matched. If the answer is yes, the virtual input device 7 is activated and the projector 76 is further turned on through the controller 78 so as to form a virtual numeric keyboard 84b in the two-dimensional (X-Y) light curtain 82. The position of the user-controlled object 9 in a two-dimensional coordinate system of the virtual numeric keyboard 84b(the two-dimensional light curtain 82) is learned through sensing and processing of the virtual input device 7 when the user-controlled object 9 (as shown in FIG. 11) has entered into the two-dimensional light curtain 82 corresponding to the virtual numeric keyboard 84b. Thus both virtual positioning in the two-dimensional coordinate system and preset systemic functions of the virtual numeric keyboard 84b(the two-dimensional light curtain 82) are achieved. Therefore the system architecture is simplified.

Refer to FIG. 14, a schematic drawing showing a virtual input device of the present invention is applied to a virtual mouse. While in use, whether the user-controlled object 9 is getting closer is detected firstly. If yes, the virtual input device 7 is activated and the projector 76 is further turned on through the controller 78. Thus a virtual mouse 84c with common mouse layout and keys is formed in the two-dimensional (X-Y) light curtain 82 by projection. When the user-controlled object 9 (as shown in FIG. 11) has entered the two-dimensional light curtain 82 corresponding to the virtual mouse 84c such as left button (L area), right button (R area), or mouse movement sensing area between the left button and the right button, the position of the user-controlled object 9 in a two-dimensional coordinate system of the virtual mouse 84c (the two-dimensional light curtain 82) is obtained through detection and processing of the virtual input device 7. Thus both virtual positioning in the two-dimensional coordinate system and system functions of the virtual mouse 84c are achieved. Therefore the structure of the virtual mouse 84c is simplified.

The virtual input device 7 further includes two indicator lights 85a, 85b used together with the virtual mouse 84c. The two indicator lights 85a, 85b are mounted in the housing 70 symmetrically with a certain interval therebetween and corresponding to the cheek part 712 of the housing 70. When an image of the virtual mouse 84c with common mouse layout and keys is formed by projection of the projector 76, the two indicator lights 85a, 85b are used for indicating the left button and the right button of the mouse respectively.

The two line sensors 74 are used to replace the techniques available now including hologram technology or optical scanning. Thus not only the risk of the camera being hacked is reduced, the amount of processing performed by the controller is reduced, the production cost is lowered, and the design is miniaturized/modularized. This is beneficial to the introduction of various input devices. Moreover, the line sensors 74 are used in combination with other projectors to form an input device such as a virtual keyboard, an access control system, a virtual switch, etc. Thus the virtual input device 7 of the present invention provides more functions and applications.

The controller 78 can be a MCU or CPU, responsible for control action of the light source, 72, the at least two line sensors 74 and the projector 76 and signal transmission therebetween. For example, the controller 78 activates the projector 76, or detect and receives coordinate signals from the at least two line sensors 74. Thus functions of the virtual input device 7 and input devices of the present invention are achieved.

The virtual input device of the present invention has features of simple structure, low production cost and durability. With a bit modification, the present invention overcomes various shortcomings of the product available now. Moreover, not only the aesthetic and decorative appearance is improved, the users' requirements for convenience and higher value added are satisfied.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A virtual two-dimensional positioning module of an input device set on a plane in use comprising an infrared (IR) laser light, at least two line sensors and a controller;
wherein the IR laser light projects a horizontal IR laser light beam to form a two-dimensional light curtain having a certain range, located close to, parallel to and over the plane;
wherein the at least two line sensors are arranged with a preset distance therebetween and used for detecting reflected light generated due t the horizontal IR laser light beam stopped by a user-controlled object when the user-controlled object has entered the two-dimensional light curtain so as to generate a linear position signal respectively;
wherein the controller is used to receive the linear position signals from the line sensors and perform processing to get position of the user-controlled object in a two-dimensional coordinate system corresponding to the two-dimensional light curtain.

2. The module as claimed in claim 1, wherein the IR laser light beam emitted from the IR laser light is passed through a wide-angle optical element to be reflected so that a light fan after reflection is larger than 90 degrees and a wide-angle two-dimensional light curtain is formed on surface of the plane.

3. The module as claimed in claim 1, wherein the at least two line sensors are parallel to each other and arranged at the left side and the right side of the IR laser light respectively.

4. The module as claimed in claim 1, wherein the user-controlled object is user's finger.

5. The module as claimed in claim 1, wherein the virtual two-dimensional positioning module is used together with a projector to form a virtual keyboard as an input device; the projector projects to form the virtual keyboard with common keyboard layout in the two-dimensional light curtain when the virtual two-dimensional positioning module is activated; the controller performs processing through detection and processing of the virtual two-dimensional positioning module to get position of the user-controlled object in a two-dimensional coordinate system corresponding to the virtual keyboard when the user-controlled object has entered the two-dimensional light curtain corresponding to the virtual keyboard.

6. The module as claimed in claim 5, wherein the virtual two-dimensional positioning module is further used together with an activation unit; the activation unit includes a sensing element that detects whether the user is approaching to use the input device.

7. The module as claimed in claim 1, wherein the virtual two-dimensional positioning module is used together with a projector to form a virtual numeric keyboard as an input device for a combination lock of an access control system; the projector projects to form the virtual numeric keyboard in the two-dimensional light curtain when the virtual two-dimensional positioning module is activated; the controller performs processing through detection and processing of the virtual two-dimensional positioning module to get position of the user-controlled object in a two-dimensional coordinate system corresponding to the virtual numeric keyboard when the user-controlled object has entered the two-dimensional light curtain corresponding to the virtual numeric keyboard.

8. The module as claimed in claim 7, wherein the virtual two-dimensional positioning module is further used together with an activation unit; the activation unit includes a sensing element that detects whether the user is approaching to use the virtual numeric keyboard as the input device for the combination lock of the access control system.

9. The module as claimed in claim 1, wherein the virtual two-dimensional positioning module is used together with a projector to form a virtual mouse as an input device; the projector projects to form the virtual mouse in the two-dimensional light curtain when the virtual two-dimensional positioning module is activated; the virtual mouse includes a left button area, a right button area and a mouse movement sensing area between the left button area and the right button area; wherein the controller performs processing through detection and processing of the virtual two-dimensional positioning module to get position of the user-controlled object in a two-dimensional coordinate system corresponding to the virtual mouse when the user-controlled object has entered the two-dimensional light curtain corresponding to the virtual mouse.

10. The module as claimed in claim 9, wherein the virtual two-dimensional positioning module is further used together with an activation unit; the activation unit includes a sensing element that detects whether the user is approaching to use the virtual mouse as the input device.

11. The module as claimed in claim 9, wherein the virtual two-dimensional positioning module forms a virtual switch; the virtual switch is changed from an “off” state to an “on” state when the virtual two-dimensional positioning module detects that the user-controlled object has entered the two-dimensional light curtain corresponding to the virtual switch; once the virtual two-dimensional positioning module detects that the user-controlled object has entered the two-dimensional light curtain corresponding to the virtual switch again, the virtual switch is shifted from the “on” state to the “off” state.

12. A virtual input device set on a plane in use comprising:
a housing that is a mask or a helmet; a front surface of the housing is face-shaped and having a forehead part, an eye part, a cheek part and a mouth part;
a light source mounted in the housing, corresponding to the mouse part of the housing and projecting light out through the mouth part to form a two-dimensional light curtain over the plane;
at least tow line sensors disposed in the housing with an interval therebetween, corresponding to the cheek part of the housing and used for detecting reflected light generated due to light from the light source stopped by a user-controlled object in the two-dimensional light curtain to generate a linear position signal respectively; and
a projector that is mounted in the housing and corresponding to the forehead part of the housing so as to project a virtual input image to the two-dimensional light curtain; the virtual input image is selected from the group consisting of an image of a virtual keyboard, an image of a virtual numeric keyboard, and an image of a virtual mouse.

13. The device as claimed in claim 12, wherein virtual input device further includes a controller and two indicator lights;
wherein the controller is mounted in the housing and used for receiving the linear position signals from the at least two line sensors and further processing the linear position signals to get position of the user-controlled object in a two-dimensional coordinate system corresponding to the two-dimensional light curtain;
wherein the two indicator lights are mounted in the housing symmetrically with a certain interval therebetween and corresponding to the cheek part of the housing; the two indicator lights are used for indicating a left button and a right button of a mouse respectively when the virtual input image is an image of the virtual mouse formed by projection of the projector.
